(19) United States
(12) Patent Application Publication
(10) Pub. No.: US 2002/0162470 A1
(43) Pub. Date: Nov. 7, 2002

(54) Press profile production method, color management method, printed sheet, and color management system

(76) Inventor: Yoshikazu Shimamura, Tokyo (JP)

Correspondence Address: SQUIRE, SANDERS & DEMPSEY L.L.P, 600 HANSEN WAY, PALO ALTO, CA, 94304-1043, US

(21) Appl. No.: 09/849,025

(22) Filed: May 4, 2001

(51) Int. Cl. B41F 1/54; B41L 5/12

(52) U.S. Cl. 101/484

(57) ABSTRACT

Press profile production, color management and printed sheet systems and methods provide for a highly accurate press profile that is unaffected by in-plane irregularity in density due to the ink keys unique to a given press in a printing process in which color management is performed. Thus, more accurate color matching can be achieved between a first press and another press or other device, among other advantages. A press profile production system according to an embodiment of the invention provides a print layout with a profiling target disposed within the width of one ink key of the press.

### BACKGROUND OF THE INVENTION

1. Field of the Invention

The present invention relates generally to industrial printing using an actual or production press and, more particularly, to a press profile production technique favorable to performing color management and achieving color matching between a press and another device (e.g. another press, digital still/video camera, image scanner, monitor, digital proofer, ink jet printer, etc.), and further to a color management technique, system and printed sheet used therein.

2. Description of Background Art

In prior plate-making and printing processes, color matching conducted in conjunction with scanning image colors (e.g. displayed on a monitor, reproduced in printed sheets, between scanners, monitors, proofers, presses or via other devices) is performed by an operator possessing specialized skill, experience and know-how; sophisticated color matching can also only be performed in a limited environment. Further, since subjective analysis is required, color-matching accuracy often varies in accordance with the abilities of the particular operator. The color matching process is also problematic in that it is not only complicated, but must be conducted again every time a new device is utilized.

In recent years, a color management system featuring an ICC (International Color Consortium) profile has been proposed as a color matching technique for the digital age, and has been attracting considerable attention. Such a system produces a device profile for each device that describes the color characteristics of the device (e.g. a digital camera, scanner, monitor, or digital proofer). A computer then performs color matching calculations on the basis of the device profiles for the subject devices. Color matching accuracy using such a system can thus be affected by the particular software or algorithms utilized (e.g. an application program interface or “API” or a color management module or “CMM”). Color matching accuracy can also be substantially affected by the device profiles that describe the color characteristics of the subject devices.

The accuracy of the device profile will be affected by a number of factors. Such factors include the makeup of the profiling target that serves as the basic data for color reproduction when producing a device profile, the number of targets, the accuracy of the profiling target measurement, and the software algorithm used to produce the device profile. However, in the case of an output device such as a digital proofer, a specific profiling target is output and the color of the profiling target is measured with a colorimeter or the like; computer calculations are then performed using a specific algorithm and a device profile is thereby produced. Accordingly, the profiling target output greatly affects the accuracy of the device profile, and it is very important to determine whether the profiling target output pinpoints the color reproduction characteristics of the subject device.

A digital proofer generally provides stable output, and no serious output accuracy problems have been indicated during device profile production. However, it is generally more difficult to obtain stable output with a press than with the digital proofer. Thus, the accuracy of a press profile produced from the printed sheet thereof can vary greatly. With particularly an offset press, ink keys used to reproduce a picture of a printed sheet in a desired gradient are also used to adjust the printing film thickness. Inevitably, variance exists in the printing density between ink keys, and it is well known that density in the lateral direction is irregular with respect to the printing direction. Such density variance occurs despite even the use of a density gauge during printing and the ink keys are operated on the basis of the density value thereof; it is therefore extremely difficult to print consistently over an entire surface of a printed sheet.

Recent technological advances have yielded systems in which accuracy improvement is sought by sampling printed sheets during printing or measuring color patches in a printed sheet online during printing, and controlling the ink keys from the measured value. However, density irregularity is nevertheless found to exist between ink keys during printing (i.e. on the order of about ±0.1 for each color). To make matters worse, four colors are generally used with offset printing: cyan (C), magenta (M), yellow (Y), and black (K). Therefore, even an in-plane density irregularity between the ink keys of only about ±0.1 for each color present in a printed sheet will greatly affect the tone of the color target, and thus the profile accuracy. Worse yet, density irregularity exists not only between ink keys (i.e. laterally with respect to the printing direction), but also lengthwise with respect to the printing direction.

Accordingly, there remains a need for highly accurate press profile production systems and methods, and particularly for offset printing.

### SUMMARY

The present invention provides a press profile production method that is favorable for highly accurate color matching when color management is performed to achieve color matching between a press (e.g., any press that has ink keys and is used for industrial printing) and another device (e.g. another press, a digital still camera, a digital video camera, an image scanner, a monitor, a digital proofer, an ink jet printer, etc.). Embodiments of the invention also provide for color matching methods capable of using such a profile, a color management system, and a printed sheet. (A press having a plurality of ink keys can include an offset press or a gravure press. However, since a press having a plurality of ink keys is generally an offset press, embodiments of the invention are particularly favorable in conjunction with an offset press.)

Methods according to embodiments of the invention include a press profile production method or a color management method in which the profile is used. Such methods comprise providing, within a print layout, a profiling target within an area equivalent to a width of one ink key of a press, thereby enabling a profiling target to be obtained that is very little affected by density irregularity between ink keys of the press. A profile with extremely high accuracy as a press profile (e.g., a type of device profile) can be produced by measuring a patch provided within the profiling target. A resulting printed sheet or color management system is also favorable when implementing the press profile production method or a color management method in which this profile is used.

Research has revealed that, when colorimetric data is obtained for a patch within a profiling target that is provided within an area equivalent to the width of one ink key of the press, a press profile enabling highly accurate color matching can be determined by obtaining calorimetric data for a gray patch obtained from at least three colors of ink from among a plurality of patches, and using the calorimetric data to produce a press profile. It is also found that, among the grays obtained from at least three colors of ink, greater accuracy will correspond with greater density. Stated alternatively, accuracy is found to be higher when the patch is a shadow rather than a medium, and a medium rather than a light. Accordingly, it is found preferable to use a patch that is more in the shadow range.

When a profiling target is provided within an area equivalent to the width of one ink key of the press and patches are disposed within the profiling target, the effect of density irregularity between ink keys in the printed sheet will be reduced even further. Even the effect of irregularity occurring in the printing direction is greatly reduced in the resulting profiling target, enabling the patches to be measured in that profiling target. As a result, it is possible to produce a press profile with even higher accuracy.

### BRIEF DESCRIPTION OF THE DRAWINGS

FIG. 1 is a diagram illustrating an example of a print layout usable in the production of a press profile according to an embodiment of the invention;

FIG. 2 is a diagram illustrating another example of a print layout usable in the production of a press profile according to an embodiment of the invention; and

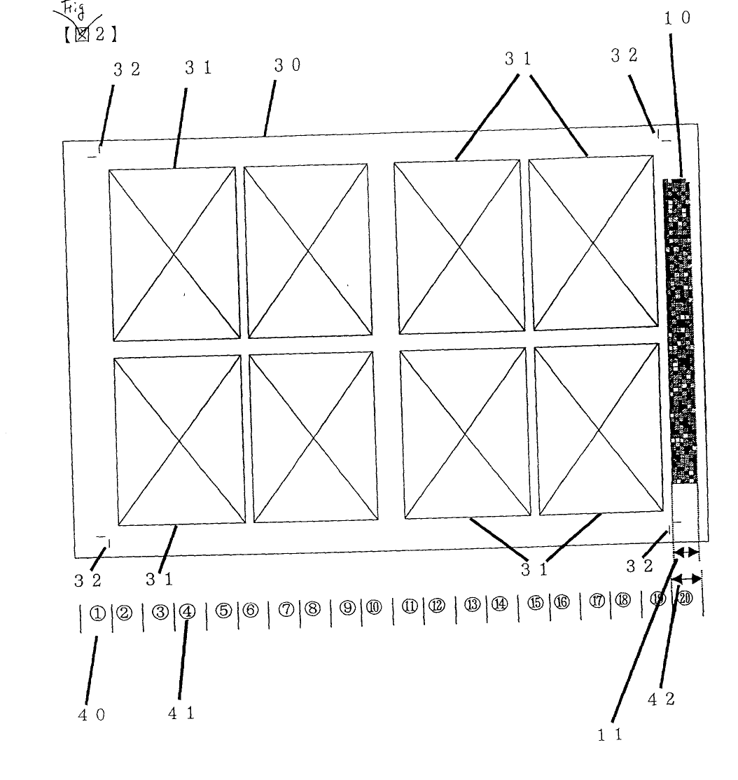

FIG. 3 is a diagram illustrating an example of a prior art print layout used in the production of a press profile.

### DETAILED DESCRIPTION

A press profile was produced using a method in accordance with an embodiment of the present invention, and color matching and digital proofing tests were conducted using this profile.

### 1. EXAMPLE 1

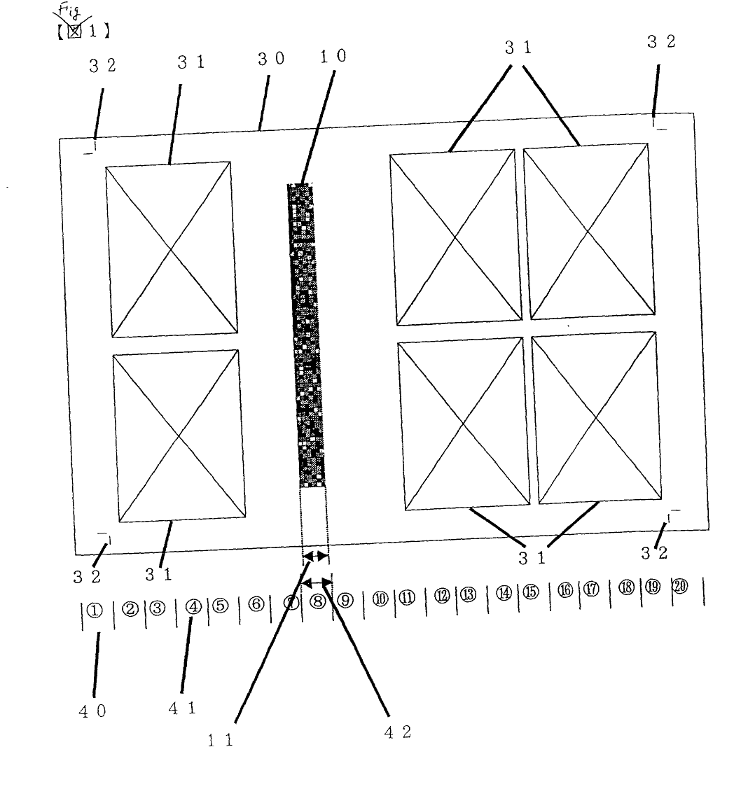

In accordance therewith, the Kodak Colorflow Profile Editor 2.0 was selected as profiling software for producing a press profile. Data obtained by modifying the layout of a profiling target 30 produced by the profiling software to form the profiling target 10 used in the current press profile production method of the present invention, and data for other pictures 31 were laid out using a DTP (desktop publishing) system. The DTP comprised a Macintosh computer and software including Photoshop 5.0 and Illustrator 8.0 from Adobe Systems, and Quark Xpress 4.0 from Quark. Printing performed using an offset rotary press from Mitsubishi Heavy Industries yielded 10,000 printed layouts for implementing the current press profile production method of the present invention, as shown in FIG. 1. A densitometer was used during printing, and the printing density was checked as needed.

A variety of pictures were used as the picture 31, but N7A (Musician) and IT8.7/3 Basic target (S7A & S8A), which are SCID images set forth in ISO 12640, were used for evaluation purposes. N7A (Musician) was used for visual evaluation, while IT8.7/3 Basic target (S7A and S8A) were used for colorimetric evaluation.

Next, to set samples for device profile production, 100 of the above-mentioned 10,000 printed sheets were collected, taking one sample from every 100 printed sheets. The best printed sheet 1 for implementing the present invention was selected as being closest to the targeted printing density, having no dirt on the profiling target and having no missing parts, soiling, or the like. In the best printed sheet 1, the profiling layout width 11 in the layout thereof is narrower than the ink key width 42 of the press, and fits within a single ink key width 42. Thus, the amount of ink of the profiling target 10 used in the press profile production method need only depend on the one ink key 40, thereby enabling the desired profiling target to be obtained without any in-plane irregularity attributable to a density difference between ink keys within this profiling target.

Using the best printed sheet for implementing the present invention and the Kodak Colorflow Profile Editor 2.0, a profile was produced for the Mitsubishi Heavy Industries offset rotary press, which is the press with which the printed sheet was printed. A Spectro Lino/Spectro Scan from Gretag Macbeth was used in the measurement of the profiling target 10.

A color matching test was then conducted for a digital proof, and also the best printed sheet with which the present invention was implemented, by means of a color management system (using the profile of an offset rotary press produced by this method of the present invention). While any commonly used digital proof can be used for this purpose, an Iris Realist FX from Scitex was used due to its relatively low cost and ease of use. The color matching test made use of N7A (Musician) and IT8.7/3 Basic target (S7A and S8A), which are SCID images set forth in ISO 12640, for evaluating the color matching of pictures 31.

The profile of the Iris Realist FX was produced using the same software and measurement equipment as those used in the production of the offset press profile above. Since none of the in-plane irregularity encountered with printed sheets produced by offset printing were encountered using the Iris Realist FX, there was no particular need to take this irregularity into account.

Next using Photoshop 5.0 from Adobe Systems as the API (Application Interface), the above-mentioned offset rotary press profile produced with the method pertaining to the present invention as the input profile, an Iris Realist FX profile as the output profile, and an Imation CFM as the CMM—N7A (Musician) and IT8.7/3 Basic target (S7A and S8A), evaluation pictures were color-converted so that the output of the Iris Realist FX would be color matched to the best printed sheet for implementing the present invention. N7A (Musician) and IT8.7/3 Basic target (S7A and S8A) data that had not undergone color management were also outputted as comparative outputs from the Iris Realist FX.

The Iris Realist FX outputs were compared to the best printed sheet for implementing the present invention and, in visual evaluation using N7A (Musician), the printed sheet that had undergone color management compared extremely well with the output with no color management (the color matching accuracy being more or less as desired). In color evaluation using IT8.7/3 Basic target (S7A and S8A), colorimetry was performed by CIELAB with a Spectro Lino/Spectro Scan from Gretag Macbeth, and the outputs of the Iris Realist FX were compared to the best printed sheet for implementing the present invention. The color difference was observed to be approximately 4.7 for an average of 182 patches in cases with no color management, whereas the color difference was only about 2.3 in cases with color management using the offset press profile produced by the method of the present invention. (Thus, the color difference was approximately halved.) The color difference of 2.3 is a general standard for color matching accuracy, and is even lower than the color difference of 3 that is often used as a target for color matching accuracy. Therefore, the color matching accuracy that can be obtained using the offset press profile obtained with a press profile production method according to an embodiment of the present invention was corroborated by experimental data as well.

### 2. EXAMPLE 2

As an example of the related art, a press profile was produced, and a color matching test of this profile and digital proofing were conducted using a method pertaining to prior art.

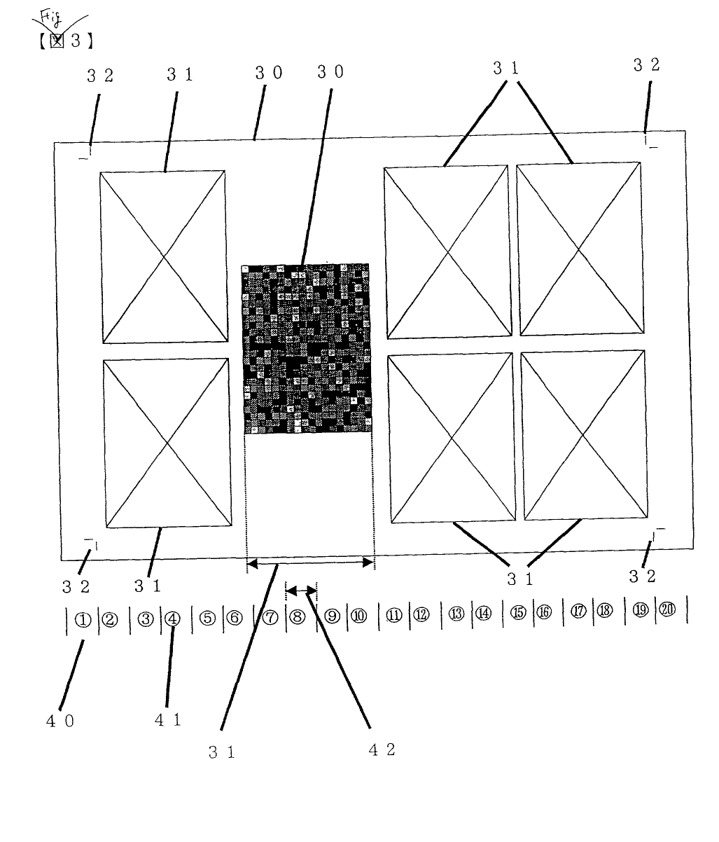

The profiling target 30 and other pictures 31 were laid out using the same DTP system as in Example 1, and printing was conducted using the same paper, ink, and printing conditions with the Mitsubishi Heavy Industries offset rotary press used in Example 1. This yielded 10,000 printed sheets for implementing a conventional press profile production method as shown in FIG. 3. A densitometer was used during printing, and the printing density was checked as needed. The pictures 31 used were also the same as those in Example 1, including N7A (Musician) and IT8.7/3 Basic target (S7A and S8A), which are SCID images set forth in ISO 12640, for evaluation purposes.

Next, to set samples for device profile production, a total of 100 of the above-mentioned 10,000 printed sheets were collected using one sample every 100 printed sheets. A suitable printed sheet sample was selected based on being closest to the targeted printing density, and having no dirt on the profiling target, no missing parts, soiling, or the like. During this sample selection, an attempt was made to select a sample with as little in-plane irregularity as possible within the profiling target. With this layout, however, the profiling target width 31 is roughly four times the ink key width 42 of the press; since the printing density of the profiling target 30 is affected by the four ink keys 40 of the press, streaks of density irregularity dependent on the ink keys occurred. There was no sample at all that was free of density irregularity. Even the best printed sheet that was eventually selected included streaks of density irregularity attributable to the ink keys that were seen within the profiling target thereof; density variance of about ±0.07 to 0.10 from the various target values for yellow, magenta, cyan, and black was noted.

Using this best printed sheet for producing a device profile by a conventional method and the Kodak Colorflow Profile Editor 2.0, a profile was produced for the Mitsubishi Heavy Industries offset rotary press and Spectro Lino/Spectro Scan from Gretag Macbeth was used in the measurement of the profiling target 30, as in Example 1.

Employing a color management system featuring this profile of an offset press produced by a conventional method, a color matching test was then conducted for a digital proof (an Iris Realist FX from Scitex) and the best printed sheet used in the production of this device profile. The color matching test was conducted in the same manner as in Example 1, using N7A (Musician) and IT8.7/3 Basic target (S7A and S8A), which are SCID images set forth in ISO 12640, laid out for evaluation of color matching from among the pictures 31. The profile of the Iris Realist FX was the same as the profile used in Example 1.

As in Example 1, Photoshop 5.0 from Adobe Systems was used as the API, further using the above-mentioned offset rotary press profile produced by a conventional method as the input profile, and using an Iris Realist FX profile as the output profile. N7A (Musician) and IT8.7/3 Basic target (S7A & S8A) data, which are evaluation pictures, were color-converted and stored as a TIFF file, after which this file was outputted by the Iris Realist FX. As in Example 1, N7A (Musician) and IT8.7/3 Basic target (S7A & S8A) data that had not undergone color management were outputted as comparative outputs from the Iris Realist FX.

The Iris Realist FX outputs were compared to the best printed sheet produced with the conventional method. In visual evaluation using N7A (Musician), the printed sheet that had undergone color management was better than the output with no color management, but the desired color matching accuracy was not achieved. In color evaluation using IT8.7/3 Basic target (S7A and S8A), colorimetry was performed by CIELAB with a Spectro Lino/Spectro Scan from Gretag Macbeth, and the outputs of the Iris Realist FX were compared to the best printed sheet with which an offset press profile was produced with the conventional method. The average color difference was approximately 4.7 for 182 patches in cases with no color management, whereas the average color difference was only about 3.9 in cases with color management. When color matching was performed using the offset press profile produced with this conventional method, there was some increase in color matching accuracy, but this was comparable to ordinary color matching accuracy, and was also somewhat higher than the color difference of 3 that is the target color matching accuracy. Therefore, the desired color matching accuracy was not attained.

In this example of the present invention, FIG. 1 was used to describe the press profile production method. However, if the profiling target used with the press profile production method of the present invention is provided to the outside of the cutting register 32 (i.e. in the area that is cut off after printing), then there will be no need to conduct a printing test for special press profile production. Thus, providing the profiling target outside the cutting register enables the press profile production method of the present invention to be applied in actual industrial printing as well.

As described above, with a press profile production method in accordance with an embodiment of the present invention, and a profile production apparatus that makes use of this method, streaks of in-plane irregularity caused by the ink keys unique to that press will have no effect whatsoever in the production of a profile. This makes it possible to produce a press profile with a high accuracy that was unattainable with a conventional method.

The preceding description is provided to enable a person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein. The embodiments described herein are not intended to be exhaustive or limiting. The present invention is limited only by the following claims.

What is claimed is:

1 A method, comprising:
printing a profiling target including a plurality of different patches onto an area of a printing surface that is located within an ink key width of an ink key of a press having one or more ink keys;
measuring a color of said patches to produce colorimetric data; and
processing the calorimetric data to produce a press profile of the press.

2 The method of claim 1, wherein the patches comprise a plurality of colors disposed at least pseudo randomly within the profiling target.

3 A profiling target produced according to the method of claim 1.

4 A method for color matching between a press and an other device, comprising:
receiving colorimetry data corresponding to patches in a profiling target printed with said press in a print layout wherein said profiling target is printed in an area of a printing surface located within an ink key width of an ink key of said press;
processing the colorimetric data to produce a press profile of the press; and
color matching the press with a color characteristic of the other device in accordance with the press profile.

5 The method of claim 4 wherein the patches comprise a plurality of colors disposed at least pseudo randomly within the profiling target.

6 The method of claim 4 wherein the other device is selected from a group including a digital still camera, a digital video camera, an image scanner, a monitor, a digital proofer, an ink jet printer, and another press.

7 The method of claim 5 wherein the other device is selected from a group including a digital still camera, a digital video camera, an image scanner, a monitor, a digital proofer, an ink jet printer, and another press.

8 A color management method, comprising:
receiving a printed sheet printed on a press and including a color;
receiving a profiling target including a plurality of different patches, at least one patch being located in an area of a printing surface located within an ink key width of an ink key of the press; and
forming a profile of said press in accordance with said profiling target; and
managing the color in accordance with at least one of the color and a density of the patch.

9 A method, comprising:
receiving a profiling target;
receiving a printed control sheet printed on a press, the control sheet including a patch in a control patch located in an area on the printed sheet located within an ink key width of an ink key corresponding to the profiling target, the control patch including a gray patch produced by at least three colors of ink, and
conducting color management in accordance with a density of the gray patch.

10 The method of claim 9, wherein the gray patch is shadow gray.

11 The method of claim 9, wherein the gray patch is medium gray.

12 The method of claim 9, wherein the gray patch includes a value between medium gray and shadow gray.

13 A control sheet produced according to the method of claim 9.
